(19) United States
(12) Patent Application Publication
(10) Pub. No.: US 2024/0111867 A1
(43) Pub. Date: Apr. 4, 2024

(54) CYBER RECOVERY FORENSICS KIT - EXPERIMENTATION AUTOMATION

(71) Applicant: Dell Products L.P., Round Rock, TX (US)

(72) Inventors: Ofir Ezrielev, Be'er Sheba (IL); Jehuda Shemer, Kfar Saba (IL); Amihai Savir, Newton, MA (US)

(21) Appl. No.: 17/937,888

(22) Filed: Oct. 4, 2022

(51) Int. Cl. G06F 21/56; G06F 21/53

(52) U.S. Cl. CPC G06F 21/566; G06F 21/53; G06F 2221/034

(57) ABSTRACT

Automated research experimentation on malware is disclosed. When malware is detected, an infected backup is generated. The infected backup is deployed to multiple working environments as recovered production systems, starting from the same state. Different scenarios are performed on the recovered production systems to learn the operational characteristics of the malware operating in the recovered production systems. The insights may be used to protect against the malware and/or other malware.

### FIELD OF THE INVENTION

Embodiments of the present invention generally relate to data protection. More particularly, at least some embodiments of the invention relate to systems, hardware, software, computer-readable media, and methods for protecting data from malware and other cyber threats.

### BACKGROUND

Most entities rely on applications and data for operational purposes. Hospitals, for example, have applications that require/use/generate data related to patients, medicines, procedures, and the like. Airlines rely on applications and data to manage flights, passengers, employees, and more. Much of this data is confidential and business critical.

These entities exert substantial efforts to ensure that their data is protected and available when needed. These efforts include generating backups of the production systems/data. Generating backups helps ensure that in the event of data loss, the production systems can be restored, and operations can resume.

Data corruption or loss, however, can occur in different ways. The loss of a disk drive due to hardware failure, for example, can be quickly resolved at least because data is often stored redundantly. The loss of data (e.g., inability to access the data) due to malware or other cyber threats, however, can be much more problematic.

Malware that infects a production system, for instance, can cause severe problems in the entity's operations. Malware may encrypt an entity's data, which may severely impact normal operations. In addition to infecting production systems, malware may also infect backups. Recovering from malware can, as a result be complicated and time-consuming. Further, the delay associated with recovering the production system may be further increased when law enforcement or insurance companies are involved as access to data may be delayed.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a forensic engine or kit configured to perform data protection operations including learning operations performed by a malware and responding to the malware;

FIG. 2 discloses aspects of a forensic engine configured to perform data operations including malware response operations;

FIG. 3 discloses aspects of automated experimentation with active malware;

FIG. 4 discloses aspects of automated experimentation with malware including generating insights on the malware's operation and operational characteristics;

FIG. 5 discloses aspects of a computing device, system, or entity

### DETAILED DESCRIPTION OF SOME EXAMPLE EMBODIMENTS

Embodiments of the present invention generally relate to data protection systems and data protection operations. More particularly, at least some embodiments of the invention relate to systems, hardware, software, computer-readable media, and methods for evaluating and/or responding to malware and other cyber-attacks.

In general, example embodiments of the invention relate to data protection operations including, but not limited to, data protection operations, backup operations, snapshot operations, restore/recover operations, point-in-time backup/recover operations, malware response operations, malware evaluation operations, automated experiment operations, twin experiment operations, or the like or combinations thereof.

The term malware, as used herein and by way of example, may refer to ransomware, viruses, rootkits, spyware, adware, trojans, worms, phishing attacks, or other unwanted software or cyber-attacks.

Embodiments of the invention relate to a forensic engine, or a forensics kit configured to evaluate and/or respond to malware. When malware is detected in a production system (or in a backup), the forensic engine may generate (or cause to be generated by a data protection system) a snapshot or other backup of the production system.

The snapshot, which includes the malware, is an infected snapshot and may be deployed to a forensics environment such that the forensic engine can research the malware and learn how the malware operates. The forensic engine allows the malware to operate in an observed manner such that operational characteristics of the malware can be learned. The operational characteristics may include determining how files are altered (e.g., deleted, changed, encrypted), how and where data is sent by the malware, how the malware spreads, how the malware response to anti-malware software, how the malware tries to avoid detection, how the malware infects backups, the order in which systems (e.g., volumes, applications, kernels, data) are infected, which components of the production system the malware infects or alters, and the like or combination thereof.

Embodiments of a forensics kit or a forensic engine are configured to learn these operational characteristics or other behavior. While learning the operational characteristics or after learning the operational characteristics, the forensic engine may be configured to operate in a proactive manner. For example, the forensic engine can trick or cause the malware to send a response malware back to the malware's source. The response malware may be able to mitigate, reverse damage caused by the malware in the production system or inflict damage on the malware host site. For example, the malware may encrypt stolen data.

In one example, malware may be configured to transmit data from the infected system back to a malware host system. The malware may also receive communications from the malware host system. In the event that these communications are interrupted or are viewed as abnormal by the malware or the malware host system, the malware may be configured to self-destruct or perform other evasive action. If this occurs prior to learning the operational characteristics of the malware, the ability to combat, thwart, or respond to the malware may not be achieved.

Embodiments of the invention relate to a forensics kit or engine that may prepare multiple working environments or infrastructure (e.g., sandboxes). The forensic engine can deploy an infected backup to each of multiple working environments. Each of the working environments may include an agent configured to execute a different scenario with respect to the recovered system, which is infected with malware. The working environments can be restarted, or new working environments can be added. In some embodiments, each of the working environments start from the same condition or state.

The agents may also be configured to learn operating characteristics of the malware from each of the different scenarios. Some of the scenarios may be rule-based scenarios and/or artificial intelligence (or other machine learning) scenarios while others may be predetermined working scenarios that are not necessarily governed by rules. In one example, the reward of the rule-based and/or artificial intelligence scenarios may be insights and heterogeneity whose values or cumulative value may be provided by a security researcher.

The system recovered from an infected backup is deployed to various working environments and execution begins from the same starting point in each of the environments in some embodiments. In addition to learning operational characteristics from each of the working environments, operational characteristics can also be learned based on how the malware operates in different scenarios.

The working environments (also referred to as working scenarios) may be configured to allow the malware to communicate with a malware host system. The communication may be emulated. By allowing the malware to communicate with the malware host system and/or allowing the malware host system to communicate with the malware, the malware continues to operate. In these examples, the working environments may be prepared with false data.

In one example, the malware may be unaware that it has been detected. In other words, this allows the malware to be evaluated in multiple difference scenarios without the attacker being aware of the fact that the malware has been detected. This allows the operational characteristics of the malware to be learned by executing the malware in multiple working environments, each of which may subject to a different scenario or different conditions.

In addition, the starting conditions of the working environments may be altered. For example, the infected backup may be deployed to multiple working environments. Some applications may be omitted from the starting conditions. Applications may be added to the starting conditions. Different starting conditions may include differences in terms of data type, directory structure, volume structure, hardware configurations and the like. These are examples of characteristics that may vary in the starting conditions. The data in the working environments may be stored in different manners using different configurations. This allows the malware to be evaluated in potential system configurations that may differ from the system configuration that was actually infected.

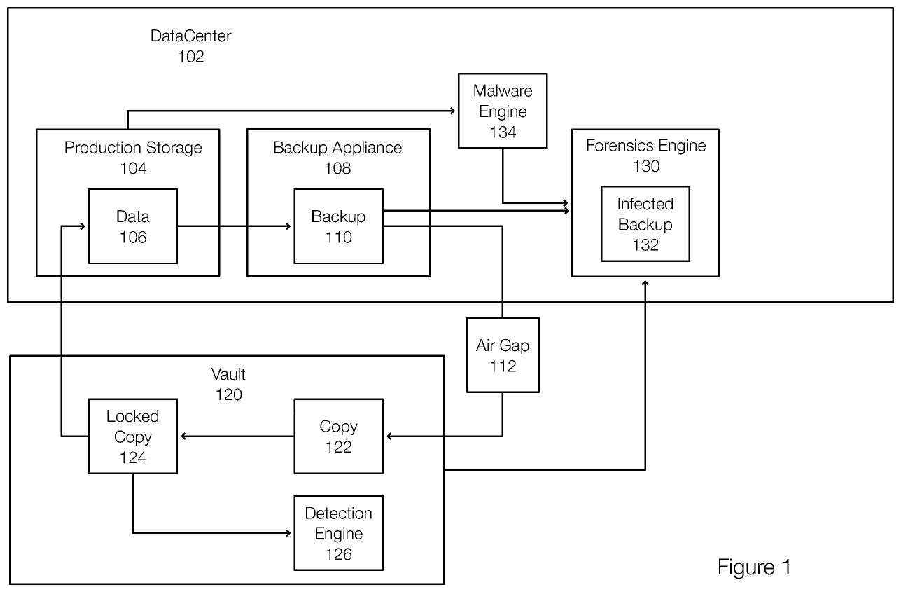

FIG. 1 discloses aspects of a forensic engine configured to perform data protection operations including malware related operations. FIG. 1 illustrates a datacenter 102 that includes production storage 104, which stores production data 106. The datacenter 102 may also host applications associated with the data 106. The production data 106 may include data required or accessed by users, applications, or the like. The data 106 may include files, objects, blocks, a database, emails, images, videos, documents, spreadsheets, presentations, or the like or combination thereof.

Although FIG. 1 illustrates production storage 104 of a datacenter 102, the production storage 104 may be an on-premise storage system, an edge system storage, or the like or combination thereof. The production storage 104 may include storage devices such as hard disk drives.

A backup appliance 108 is configured to generate and store backups of the data 106 (and/or applications), represented as the backup 110. The backup 110 may be a full backup, a synthetic backup, incremental backups, snapshots, or the like. The backup appliance 108 may be a virtual system/appliance or a physical system/appliance.

More generally, the backup appliance 108 may protect data, applications, or the like of a production system. The backup appliance 108 may transmit the backup 110 to a vault 120, which may be protected by an air gap 112 controlled by the vault 120. This allows a copy 122 of the data 106 to be stored in the vault 120 only when a connection is available (e.g., the air gap 112 is configured to allow communication or access). After ingestion into the vault, the copy 122 is locked to generate a locked copy 124. The locked copy 124 is immutable in one example. The vault 120 may be created in the datacenter 102 or in another location that is remote from the data 106 and/or the backup appliance 108.

During a recovery operation, the data 106 may be recovered from the locked copy 124 (or other backup in the vault 120). In some examples, the data 106 may be recovered from the copy 122 if necessary. In some examples, recovery may be performed from backups that have are still resident on the backup appliance 108. In one example, the backup 110 may be a namespace that is backed up to a namespace in the vault 120. The backup 110 may be transmitted to a namespace in the vault 120 as the copy 122. Next, the copy 122 may be copied to another namespace and retention locked, which results in the locked copy 124.

Once the locked copy 124 is generated and retention locked, the immutability is guaranteed in one example. For example, the locked copy 124 is secure from attack vectors that adversely impact backups because the vault 120 may not be accessible, due to the air gap 112, which is controlled from inside the vault 120 in one example.

The air gap 112 may not be present in other backup storage environments but provides a more secure backup environment. In one example, the vault 120 may be a target site (e.g., a cloud, edge, or on-premise site) that is not protected by an air gap but is configured to store backups received from the backup appliance 108. The vault 120 may be associated with a corresponding appliance that may be configured to store the backups in the target site and also perform restore or recover operations. In one example, the air gap 112 is not present and the value 120 may simply represent backup storage that stores backups received from the backup appliance 108.

The production storage 104 (or more generally the production system) may be associated with a malware engine 134. When the malware engine 134 detects malware in the production storage 104 or more generally in the production system (or backup) or if the malware is detected in another manner, the malware engine 134 may trigger the forensic engine 130. The forensic engine 130 may be triggered in another manner or may include the malware engine 134.

When triggered, the forensic engine 130 may generate a snapshot (e.g., a point-in-time snapshot) or other backup of the production system or receive a current snapshot from the backup appliance 108, which is illustrated as an infected backup 132. The infected backup 132 may be taken from the data 106, may be a PiT copy or generated from the backup 110, or the like. In one example, the infected backup 132 is a most recent point-in-time backup. However, the infected backup 132 may represent different point in time and/or different backup types.

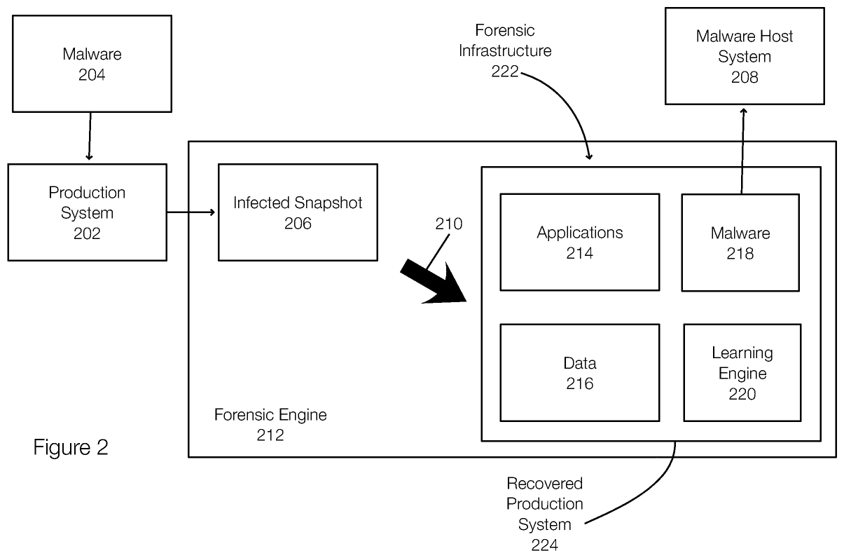

FIG. 2 discloses aspects of performing malware related operations. In FIG. 2, malware 204 has infected a production system 202. When detected, this triggers a snapshot or backup operation by the forensic engine 212 (or the backup appliance), which generates an infected snapshot 206. The forensic engine 212 may deploy 210 the infected snapshot 206 to a forensic infrastructure 222, which may be capable of providing multiple working environments. Each of the working environments may be a sandbox. The forensic infrastructure 222 may be configured to appear as a real system. This allows the infected snapshot 206 to operate in the forensic infrastructure 222 as if it were a production system.

Thus, the infected snapshot 206 may be recovered to the forensic infrastructure 222 (e.g., to a specific working environment) as the recovered production system 224. The malware 204 is represented as the malware 218 in the recovered production system 224. Thus, the recovered production system 224, which is infected with the malware 218, is recovered to the forensic infrastructure 222 and includes applications 214, data 216, and a learning engine 220. The learning engine 220 may be added by the forensic engine 212. More specifically, the learning engine 220 may be deployed to the recovered production system 224 in the forensic infrastructure 222. Alternatively, the learning engine 220 may learn operational characteristics of the malware 218 from outside of the working environment.

The learning engine 220 is configured to learn the operational characteristics of the malware 218. This may include monitoring and observing the operation of the malware 218. This allows the learning engine 220 to determine what files in the data 216 are accessed by the malware 218, learn when the files are accessed, the order in which files/systems/drives are accessed, learn functions performed by the malware 218, monitor communications with a malware host system 208, and the like. The learning engine 220 may learn when the malware 218 acts, how the malware 218 replicates or spreads, how the malware 218 attempts to avoid detection, and the like. The learning engine 220 may log actions performed by the malware 218 or the like. The insights learned by or gleaned from an output of the learning engine 220 are collectively referred to as the operational characteristics of the malware 218.

The output (e.g., the operational characteristics, insights, or the like) of the learning engine 224 may be analyzed by the forensic engine 212 or by a user. This allows the forensic engine 212 to perform both reactive and proactive actions. For example, the forensic engine 212 or production system 202 may be able to react more quickly in the event that the malware 218 reoccurs. The forensic engine 212 may be able to prevent future infections of the malware 218.

In one example, the infected snapshot 206 may be recovered to an infrastructure 222 where the data 216 is fake or false data. Thus, the real data may be replaced with false data that appears real to the malware 218. In the event that the forensic infrastructure 222 operates in a live manner, any data exported by the malware 218 is benign and non-damaging to the production system 202.

In one example, the false data 216 appears to be real, but does not prejudice the production system 202. Some working environments may be live and allow the malware to communicate externally. Because the working scenario 222 may be operating in a live manner, any data exported by the malware 218 is benign and non-damaging to the production system 202. Because the communication 226 is also uninterrupted, the malware host system 208 believes that the malware 218 has not been detected. This allows the learning engine 220 to learn the operational characteristics of the malware 218 and/or the malware host system 208.

When preparing a working scenario or when recovering from an infected backup, the recovery system may be configured to recover fake or false data to the working environment along with the malware. The malware protection operations may be configured to prevent the malware from discovering it has been detected. This may include recovering false data as part of the recovery operation rather than recovering into a system prepared with false data.

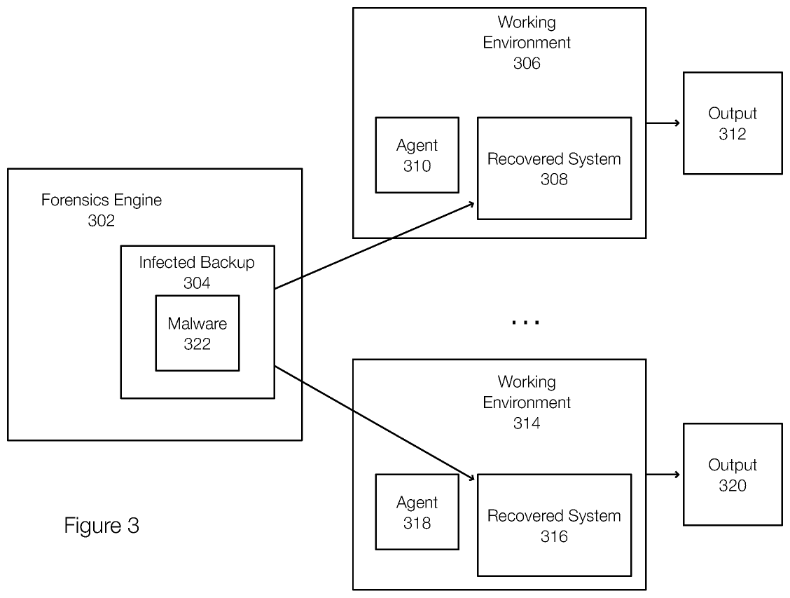

FIG. 3 discloses aspects of experimentation automation. In FIG. 3, the forensic engine 302 may have received an infected backup 304. The infected backup 304 may be run in a working environment 306 as a recovered system 308 and as a recovered system 316 in a working environment 314. In one example, the starting conditions and characteristics of the working environments 306 and 314 are the same.

The working environments 306 and 314 may be representative of multiple working environments. The agent 310 is configured to conduct an experiment on the recovered system 308 to learn at least some of the operational characteristics of the malware 322 in the working environment 306. Similarly, the agent 318 is configured to learn at least some of the operational characteristics of the malware 322 in the working environment 314.

In one example, the agent 310 and the agent 318 may each implement a scenario. However, these scenarios are different. Thus, even though the recovered systems 308 and 316 start from the same state or conditions, the activities performed (e.g., function execution, operating system functions, reads, writes, imports, exports, backups) may occur or progress differently.

For example, the agent 310 may cause the recovered system 308 to perform database operations first while the agent 318 may cause the recovered system 316 to perform email operations. Thus, the activities can vary in type, order of performance, and the like. Activities may include size of writes, size of reads, data manipulation (move file, copy file, delete file), or the like. Operating system operations, application operations, and the like may also vary.

If the agents 310 and 318 are, in effect, performing a predetermined set of actions, the response of the malware 322 to these actions and/or to the order of the actions can be observed and recorded. The number of scenarios that can be performed by the agent 310 is large.

In another example, the scenarios performed by the agents 310 and 318 may be less strict. For example, the agents 310 and 318 may implement rule-based scenarios, artificial intelligence scenarios, or the like. More generally, a rule-based scenario may simply perform a list of predetermined actions and observe the response of the malware. An artificial intelligence scenario may also use rules. However, the response of the artificial intelligence scenario may not be as rigid as a strictly rule-based scenario. The rules of an artificial intelligence scenario may be configured to produce an outcome in one example. The rules may be configured to respond according to actions of the malware 322. For example, if the malware 322 accesses a particular volume, the rule may require additional data to be written to the same particular volume. The response of the malware 322 may then be recorded. Alternatively, the rule may be to write data to a different volume in response to data written to that volume. These types of rules and variations can be tested in the working environments. Machine based learning models may also be employed to learn the behavior of malware and then generate recommended actions.

This may allow, for example, the forensic engine 302 to identify actions that tend to slow the spread of the malware 322, actions that may increase the speed of infection, actions that are not affected by the malware, actions that cause the malware to act, spread, or the like.

For example, if a malware attempts to learn the topography of a production system in preparation for an encryption operation, the working environments 306 and 314 may allow the forensic engine 302 to determine when the encryption operation is triggered. The working environments may determine or identify a function of the malware, such as replication, application installation (e.g., keystroke or commandeering applications, blocking file/application access, ad attacks, impacting device operability, or the like.

Insights from the agents 310 and 318 may allow differences in the final state of the recovered systems 308 and 316 to generate insights that can be applied to the original production system. These insights may allow the production system to more quickly detect malware, be immune from certain malware, prevent data from being encrypted, or otherwise protect the production system. Further, insights gained from the outputs 312 and 320 of the working environments 306 and 314 may be used to protect against currently unknown malware, which may have similar operational characteristics.

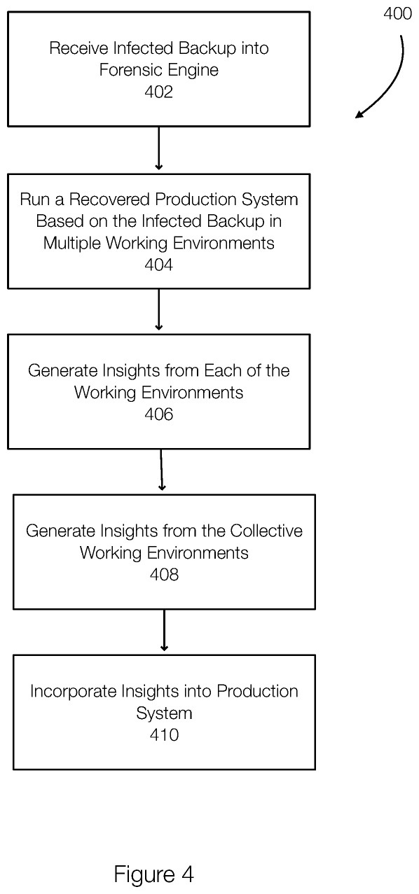

FIG. 4 discloses aspects of automating malware experimentation. In a method 400, an infected backup may be received 402 at a forensic engine. The infected backup may be recovered as a recovered production system that is run 404 in multiple working environments. Each of the working environments may include an agent that is configured to implement a scenario. As a result, each of the recovered production system operates in a controlled manner and in different manners. Some of the agents may implement a predetermined scenario while other agents may implement a rule based artificial intelligence scenario. These various scenarios can also be changed and re-executed from the same starting point or from different starting points or conditions.

Insights may be generated 406 from each of the working scenarios. Insights may also be generated 408 from the collective insights (e.g., differences and/or similarities of the individual insights) from the scenarios executed in the recovered production systems.

The insights may be incorporated 410 into a production system, a data protection system (e.g., a backup appliance) or a malware protection system.

Embodiments of the invention automate research experimentation on malware using different scenarios in different working environments. This automates and improves the ability to generate, collect, and act on insights regarding malware.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, malware detection operations, malware evaluation operations, malware experimentation operations, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the PowerProtect and CyberRecovery platforms and associated backup software, and storage environments such as the Dell-EMC DataDomain storage environment. In general, however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving an infected backup of a production system at a forensic engine, the infected backup including a malware, deploying the infected backup to working environments such that each of the working environments includes a recovered production system, performing a different scenario in each of the recovered production system to learn operational characteristics of the malware from outputs of each of the working environments individually and from the outputs of the working environments collectively, and implementing the insights in a production system.

Embodiment 2. The method of embodiment 1, wherein at least one of the scenarios is a predetermined set of actions performed by an agent.

Embodiment 3. The method of embodiment 1 and/or 2, wherein at least one of the scenarios is a rule-based scenario or a rule-based artificial intelligence scenario or a machine learning model scenario performed by an agent.

Embodiment 4. The method of embodiment 1, 2, and/or 3, wherein the each of the working environments are executed in a sandbox.

Embodiment 5. The method of embodiment 1, 2, 3, and/or 4, wherein at least some of the working environments allow communication between the malware and a malware host system.

Embodiment 6. The method of embodiment 1, 2, 3, 4, and/or 5, wherein the infected backup is a most recent point-in-time of the production system.

Embodiment 7. The method of embodiment 1, 2, 3, 4, 5, and/or 6, wherein the working environments are configured to prevent the malware from knowing that the malware has been detected.

Embodiment 8. The method of embodiment 1, 2, 3, 4, 5, 6, and/or 7, further comprising detecting the malware in the production system or in a backup.

Embodiment 9. The method of embodiment 1, 2, 3, 4, 5, 6, 7, and/or 8, further comprising generating the backup when the malware is detected.

Embodiment 10. The method of embodiment 1, 2, 3, 4, 5, 6, 7, 8, and/or 9, further comprising providing each of the working scenarios with false data.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’, ‘component’, ‘agent’, or ‘engine’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

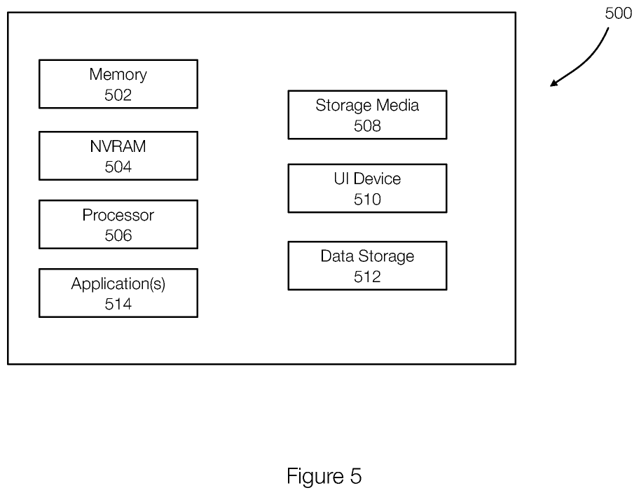

With reference briefly now to FIG. 5, any one or more of the entities disclosed, or implied, by the Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid-state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving an infected backup of a production system at a forensic engine, the infected backup including a malware;
deploying the infected backup to working environments such that each of the working environments includes a recovered production system;
performing a different scenario in each of the recovered production system to learn operational characteristics of the malware from outputs of each of the working environments individually and from the outputs of the working environments collectively; and
implementing the insights in a production system.

2. The method of claim 1, wherein at least one of the scenarios is a predetermined set of actions performed by an agent.

3. The method of claim 1, wherein at least one of the scenarios is a rule-based scenario or a rule-based artificial intelligence scenario or a machine learning model scenario performed by an agent.

4. The method of claim 1, wherein the each of the working environments are executed in a sandbox.

5. The method of claim 1, wherein at least some of the working environments allow communication between the malware and a malware host system.

6. The method of claim 1, wherein the infected backup is a most recent point-in-time of the production system.

7. The method of claim 1, wherein the working environments are configured to prevent the malware from knowing that the malware has been detected.

8. The method of claim 1, further comprising detecting the malware in the production system or in a backup.

9. The method of claim 1, further comprising generating the backup when the malware is detected.

10. The method of claim 1, further comprising providing each of the working scenarios with false data.

11. A non-transitory storage medium having stored therein instructions that are executable by one or more hardware processors to perform operations comprising:
receiving an infected backup of a production system at a forensic engine, the infected backup including a malware;
deploying the infected backup to working environments such that each of the working environments includes a recovered production system;
performing a different scenario in each of the recovered production system to learn operational characteristics of the malware from outputs of each of the working environments individually and from the outputs of the working environments collectively; and
implementing the insights in a production system.

12. The non-transitory storage medium of claim 11, wherein at least one of the scenarios is a predetermined set of actions performed by an agent.

13. The non-transitory storage medium of claim 11, wherein at least one of the scenarios is a rule-based scenario or a rule-based artificial intelligence scenario or a machine learning model scenario performed by an agent.

14. The non-transitory storage medium of claim 11, wherein the each of the working environments are executed in a sandbox.

15. The non-transitory storage medium of claim 11, wherein at least some of the working environments allow communication between the malware and a malware host system.

16. The non-transitory storage medium of claim 11, wherein the infected backup is a most recent point-in-time of the production system.

17. The non-transitory storage medium of claim 11, wherein the working environments are configured to prevent the malware from knowing that the malware has been detected.

18. The non-transitory storage medium of claim 11, further comprising detecting the malware in the production system or in a backup.

19. The non-transitory storage medium of claim 11, further comprising generating the backup when the malware is detected.

20. The non-transitory storage medium of claim 11, further comprising providing each of the working scenarios with false data.
